(19) United States
(12) Patent Application Publication
(10) Pub. No.: US 2025/0303860 A1
(43) Pub. Date: Oct. 2, 2025

(54) DISPLAY SYSTEM FOR A VEHICLE

(71) Applicant: AUDI AG, Ingolstadt (DE)

(72) Inventor: Jacques HÉLOT, Ingolstadt (DE)

(21) Appl. No.: 19/086,883

(22) Filed: Mar. 21, 2025

(30) Foreign Application Priority Data
Mar. 27, 2024 (DE) 10 2024 108 820.6

(51) Int. Cl. B60K 35/231; B62D 1/20; G02B 27/01

(52) U.S. Cl. CPC B60K 35/231; B62D 1/20; G02B 27/0101; B60K 2360/23

(57) ABSTRACT

A display system for a vehicle having a steering column with a housing is disclosed, and may comprise at least one optical module, one opening in the housing, and one display panel. The at least one optical module may be arranged within the housing of the steering column. The display panel may be arranged on the housing and may be configured to be movable relative to the opening, to cover the opening in the upper side of the steering column in a covering mode, and to uncover the opening in the steering column in a projection mode. The at least one optical module may be configured to emit an image through the uncovered opening in the housing onto the display panel when the display panel is in the projection mode. The display panel may be configured to reflect the image emitted thereon into an interior of the vehicle.

### BACKGROUND

### Technical Field

The present disclosure relates to a display system for a vehicle and a method for operating a display system.

### Description of the Related Art

DE102005012848A1 describes a built-in communication instrument for a motor vehicle.

A display device for a motor vehicle is known from U.S. Pat. No. 5,059,956.

### BRIEF SUMMARY

The display system according to the present disclosure is configured for a vehicle, for example a motor vehicle. The display system described herein provides a space saving display for the vehicle. The vehicle has a steering column with a housing and a steering wheel rotatably arranged thereon. The display system may have at least one optical module, i.e., only one optical module or several optical modules, for generating and/or reflecting light for an image to be shown or to be displayed. In addition, the display system may have an opening in, at, and/or on an upper side of the housing, and a display panel. The at least one optical module may be arranged within the housing of the steering column or in an interior of the steering column enclosed by the housing. The display panel may be arranged on the upper side of the housing so as to be movable relative to the opening and may be configured to cover the opening in the upper side of the steering column in a covering mode or covering position as a resting mode or resting position and to uncover it to the outside in a projection mode or projection position as an uncovering mode or uncovering position. The at least one optical module may be configured to generate an image or light for the image and to emit or radiate the image or light for the image through the uncovered opening in the housing onto the display panel when in the projection mode. The display panel may be configured to reflect the image emitted thereon into an interior of the vehicle.

In some embodiments, a display field or display may be provided as an optical module of the display system, wherein such a display field may also be configured as a projector, imager, and/or image generator. The display field may be referred to as a projector, imager, and/or image generator herein. The display field may be arranged within the housing of the steering column and may be configured to generate the image or light for this purpose.

In some embodiments, the display system may have the display field as the only optical module, which may be configured to emit the image generated thereby through the uncovered opening in the housing directly onto the display panel when in the projection mode, wherein the display panel may be configured to reflect the image emitted thereon into the interior of the vehicle.

In some embodiments, a mirror may be arranged as a further optical module within the housing of the steering column. In such embodiments, the display field may be configured to first generate an original image and to emit and/or project the original image onto the mirror. The mirror may be configured to reflect the original image as a reflected or mirrored image through the uncovered opening in the housing to the outside onto the display panel when in the projection mode. When in the projection mode, the display panel may be configured to reflect or mirror the image reflected or mirrored thereon as a virtual image into an interior of the vehicle. In doing so, the image originally generated by the display field is emitted indirectly onto the display panel via the mirror.

In some embodiments, the mirror may be arranged in the steering column and/or in housing of the steering column in front of the display field, e.g., the projector, with respect to a forward direction of travel of the vehicle. In alternative embodiments, the display field may be arranged in front of the mirror with respect to the forward direction of travel. The display panel may be arranged above the mirror at least when in the projection mode. Furthermore, the mirror, the display panel, and the display field may be arranged in front of the steering wheel with respect to the forward direction of travel. In the projection mode, the display panel may face the steering wheel.

The display panel or a surface thereof may be at least partially or completely curved, and/or at least partially or completely planar (i.e., level or flat). The display panel or the surface thereof may be curved in a concave manner. In addition, the display panel or the surface thereof may be configured to be at least partially or completely opaque or non-transparent and/or at least partially or completely transparent. In addition, the display panel or the surface thereof may be configured to be at least partially or completely mirrored or light-reflecting and, in some embodiments, may be dark, e.g., colored black. The reflective surface of the display panel may be oriented towards the steering wheel when the display panel is in the projection mode.

The housing of the steering column may be non-transparent. If the display panel is in the projection mode, light from the interior of the steering column, which may be enclosed by the housing except for the uncovered opening, may escape from the interior if reflected by the mirror onto the display panel or emitted by the imager onto the display panel. In some embodiments, a cover panel that is transparent to light may be arranged in the opening in order to protect the interior from environmental influences, e.g., dust. If the display panel is in covering mode, the display panel may rest on the cover panel. In the projection mode, light that is reflected upwards by the mirror or emitted upwards by the display field may be reflected through the opening and the transparent cover panel to the display panel.

In some embodiments, the display system may have an electrical mechanism or electrical mechanics which may be configured to automatically pivot and/or rotate the display panel relative to the opening between the covering mode and the projection mode as two possible modes of the display panel, such that the display panel acts as a cover for the opening in the housing. The mechanism may have a hinge on which the display panel is arranged so as to be pivotable and/or rotatable at an edge of the opening.

The display system may be provided for a steering column in which a steering shaft is arranged, which connects the steering wheel to a steering system for wheels of the vehicle as a transmission element, wherein the wheels are in contact with a surface on which the vehicle is located and are designed to drive and/or move the vehicle. In some embodiments, the display system may also comprise the steering column and/or the housing of the steering column, in which the at least one optical module, i.e., the display field and possibly the mirror, is arranged.

The method according to the present disclosure is provided for operating a display system for a vehicle, wherein the vehicle has a steering column with a housing and a steering wheel rotatably arranged thereon. The display system may have at least one optical module, in other words an optical module which may be configured as a display field or image generator for an original image, and, in some embodiments, the display system may also have a mirror as a further optical module. In addition, the display system may have an opening in, on, and/or at an upper side of the housing, and a display panel. In such embodiments, the at least one optical module may be arranged inside the housing of the steering column. The display panel may be arranged in or at the upper side of the housing so as to be movable relative to the opening, wherein the opening in the upper side of the steering column may be covered by the display panel in a covering mode and uncovered in a projection mode. In addition, an image may be generated by the at least one optical module and emitted through the uncovered opening in the housing directly or indirectly onto the display panel when in the projection mode, wherein the image may be reflected from the display panel into an interior of the vehicle to a viewer.

If the display system has the display field and the mirror as optical modules, an original image may be emitted and/or projected from the display field onto the mirror, wherein the original image may be reflected as a reflected or mirrored image by the mirror through the uncovered opening in the housing onto the display panel when in the projection mode, wherein the image reflected or mirrored onto the display panel when in the projection mode may be reflected or mirrored by the display panel as a virtual image into an interior of the vehicle to a viewer, e.g., a driver behind the steering wheel.

It some embodiments, the method presented herein may be executed with an embodiment of the display system disclosed herein that is connected to the steering column of the vehicle and/or integrated therein, wherein the display system may have either the display field as the only optical module or the display field and the mirror as two optical modules in an interior of the steering column. In some embodiments, the display system may have several mirrors and/or at least one lens as optical modules.

In some embodiments of the method, the display panel may be moved, i.e., pivoted and/or rotated, between the covering mode as the resting mode and the projection mode, wherein starting from the covering mode in which the display panel is in the opening, the display panel may be pivoted and/or folded upwards into the projection mode. Conversely, the display panel may be pivoted and/or folded from the projection mode into the covering mode and placed back in the opening. Here, the display panel may be moved automatically by the mechanism if the mechanism is controlled by an input command from the viewer.

If the display system has only the mirror as the optical module, light for the original image or for a display content to be displayed may be reflected from the display field upwards onto the display panel and reflected by the display panel into the interior in the forward direction of travel and at least partially in the direction of the steering wheel.

If the display system has both optical modules, the mirror may be arranged in front of the display field with respect to the forward direction of travel of the vehicle, with the mirror being oriented relative to the forward direction of travel, for example in the forward direction of travel and upwards. In such embodiments, the display field may be located between the mirror and the steering wheel. In such embodiments, light for the original image or for a display content to be displayed may be emitted from the display field forward onto the mirror, reflected from there upward onto the display panel, and reflected by the display panel into the interior in the forward direction of travel and at least partially in the direction of the steering wheel.

If, conversely, the display field is arranged in front of the mirror with respect to the forward direction of travel of the vehicle, the mirror may be oriented relative to the forward direction of travel, e.g., in a forward direction and upwards. In such embodiments, the mirror may be located between the display field and the steering wheel. In such embodiments, light for the original image or for a display content to be displayed may be emitted from the display field backward onto the mirror, reflected from there upward onto the display panel and reflected by the display panel into the interior in the forward direction of travel and at least partially in the direction of the steering wheel.

The display system may be configured as a black-print display on the steering column and/or as a head-up display (HUD) if the display panel or its surface is black, e.g., coated in black. The display system may be referred to as a black-print display and/or as a HUD. The image may be emitted from the display field in the steering column onto the display panel that is folded out of the opening in the projection mode. Alternatively, the image generated by the display field and emitted onto the mirror may be mirrored via the mirror onto the display panel that is folded out of the opening in the projection mode.

Based on a reflection of the image on the display panel, a virtual image may be created for a viewer in front of the steering column.

The display panel may be as wide as the steering column at most. The virtual image may be wider than the steering column and/or the display panel. The display system may be used to display combination contents as images, such as on an instrument panel, that comprise functions and/or operating parameters of the vehicle. The virtual image may be displayed in the interior regardless of the shape and inclination of a windshield, wherein the display system may be suitable for both a flat windshield that is inclined at a small angle that is smaller than, for example, 600 relative to the forward direction of travel, and for a steep windshield that is inclined at a large angle that is at least 600 and a maximum of 90° relative to the forward direction of travel, wherein a vehicle with a flat windshield has low air resistance. The display system presented may compensate for tolerances, for example structural tolerances. In addition, the display system may consume little installation space in the vehicle.

In a head-up display, as is known from the prior art, the image may be reflected starting from a windshield into the interior and displayed as a virtual image. In the display system, a reflective surface for the virtual image may be decoupled from the windshield and positioned on the pivoting display panel on the steering column.

In the display system, the display panel may be positioned very close to the steering wheel. The image may be redirected via the display field or the mirror in the steering column and also via the folded-out display panel far in front of the steering column. The display panel may be mirrored. The mirror may be arranged firmly, e.g., stationarily or rigidly, in the steering column. The mirror may be arranged within the steering column so as to be rotatable about a transverse axis of the vehicle, with the transverse axis being oriented perpendicular to the forward direction of travel. Alternatively or in addition, the display field or display in the steering column may be arranged firmly, e.g., stationarily or rigidly, in the steering column. The display field or the display in the steering column may also be arranged within the steering column so as to be rotatable about a transverse axis of the vehicle, with the transverse axis being oriented perpendicular to the forward direction of travel.

As a result, the resulting virtual image may appear to the viewer in the area of a lower edge of the windshield. The viewer only may only have to accommodate their eyes slightly when switching their gaze between the virtual image and the surroundings of the vehicle, e.g., the road. If the display panel is folded in, the steering column may be configured to be compact and/or slim. Since the display system is completely housed in the steering column, the control panel in front of the steering column may be slim, providing an improved view to the front and a greater sense of space. In some embodiments of the method, the display field and the mirror may move together and/or synchronously, with both being rotated about a respective transverse axis. The virtual image to be displayed may always be clearly visible to the viewer, regardless of the respective setting and/or position of the steering wheel.

It should be understood that the features mentioned above and those to be explained below can be used not only in the combination specified in each case, but also in other combinations or on their own, without departing from the scope of the present disclosure.

### BRIEF DESCRIPTION OF THE SEVERAL VIEWS OF THE DRAWINGS

FIG. 1a shows a schematic representation of a cross-sectional view of a first embodiment of the system according to the present disclosure.

FIG. 1b shows a schematic representation of a perspective view of the first embodiment of the system according to the present disclosure.

FIG. 1c shows a schematic representation of a perspective view of the first embodiment of the system according to the present disclosure.

FIG. 2 shows a schematic representation of a cross-sectional view of a second embodiment of the system according to the present disclosure.

### DETAILED DESCRIPTION

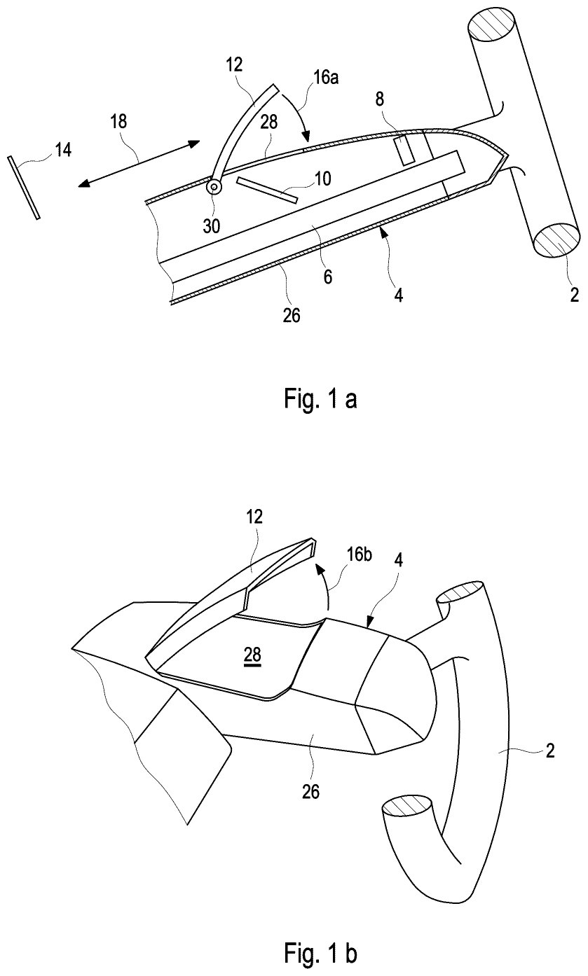

FIGS. 1a, 1b and 1c show from different perspectives a steering wheel 2 of a vehicle, here a motor vehicle, which is arranged here on a steering column 4 of the vehicle. Steering column 4 may comprise a non-transparent housing 26 in which a steering shaft 6 may be arranged as a mechanical transmission element, which connects steering wheel 2 to a steering system for wheels of the vehicle.

The first embodiment of the display system according to the present disclosure may comprise an opening 28, which may be arranged in an upper side of housing 26 of steering column 4. The display system may also comprise a display field 8 or a display as the first optical module and a mirror 10 as the second optical module, which may be arranged in an interior of steering column 4 above steering shaft 6, which may be enclosed by housing 26. Mirror 10 may be inclined at an acute angle relative to steering shaft 6. The display system furthermore may have a concavely curved display panel 12, which may be attached to an edge of opening 28 so as to be pivotable and/or rotatable relative to opening 28 via a mechanism 30, which may have at least one hinge, movement of which is indicated in the figures by curved arrows 16a, 16b. Alternatively, display panel 12 may be planar.

Here, display field 8 is arranged between steering wheel 2 and mirror 10. Opening 28 and display panel 12 may be arranged above mirror 10. In addition, FIG. 1c shows switching elements 20a, 20b, which are arranged here, for example, on the left and right at ends of wing-shaped structural components of housing 26, on housing 26 of steering column 4, wherein a function of the vehicle and/or of the display system presented may be controlled by actuating switching elements 20a, 20b. The actuating switching elements 20a, 20b may be wireless or radio-based switching elements 20a, 20b (e.g., Sbw, shift-by-wire).

In the first embodiment of the method according to the disclosure, at least two modes may be provided for display panel 12, which may include a projection mode, which is shown in FIGS. 1a to 1c, and a covering mode. In the embodiment shown in FIGS. 1a to 1c, in the covering mode, display panel 12 may be pivoted downwards, with opening 28 being covered and/or closed by display panel 12. In such an embodiment, the display panel 12 may be arranged in opening 28 as part of housing 26.

In contrast, in the projection mode, display panel 12 may be pivoted upward out of opening 28, wherein opening 28 may be uncovered and/or opened. In the embodiment shown in FIGS. 1a to 1c, a reflective or mirrored surface of display panel 12 faces steering wheel 2. In the method, an original image 14 may be generated by display field 8 and, in the embodiment shown in FIGS. 1a to 1c, may be emitted and/or projected parallel to steering shaft 6 to or onto mirror 10. The original image 14 may then reflected upwards as first reflected image 14 by mirror 10 onto the mirrored surface of display panel 12. From there, image 14 may be reflected in the direction of steering wheel 2 and into the interior. In the embodiment shown in FIGS. 1a to 1c, a viewer, such as a driver of the vehicle, may visually perceive a resulting virtual image 14 in the interior behind steering wheel 2, which may appear to the viewer at a distance behind display panel 12 indicated by a double arrow 18 (FIG. 1a).

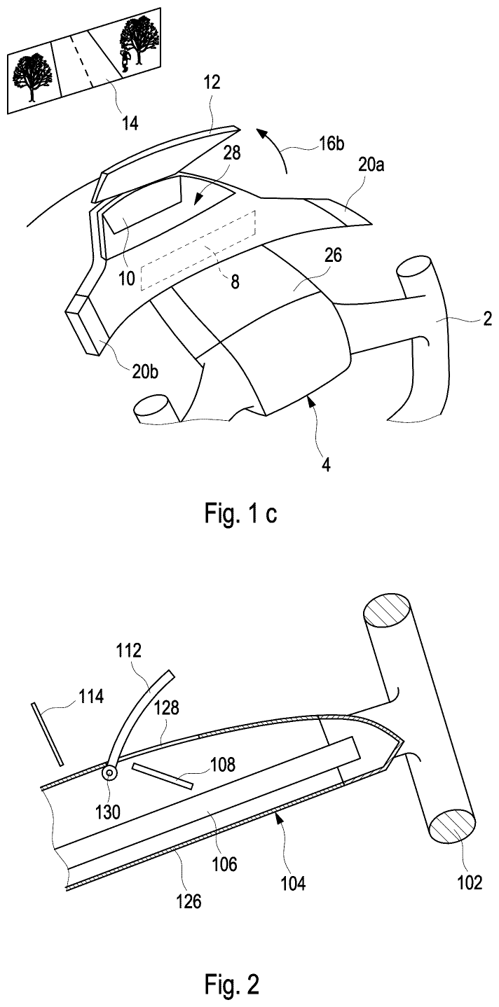

FIG. 2 shows a steering wheel 102 of a vehicle, here a motor vehicle, which is arranged on a steering column 104 of the vehicle. Steering column 104 may comprise a non-transparent housing 126 in which a steering shaft 106 may be arranged as a mechanical transmission element, which connects steering wheel 102 to a steering system for wheels of the vehicle.

The second embodiment of the display system according to the present disclosure may comprise an opening 128 arranged in an upper side of housing 126 of steering column 104. In addition, the display system may comprise, as the only optical module, a display field 108 or a display arranged in an interior of steering column 104 above steering shaft 106, which may be enclosed by housing 126. Display field 108 may be inclined at an acute angle relative to steering shaft 106. Furthermore, the display system may have a concavely curved display panel 112 which may be attached to an edge of opening 128 so as to be pivotable and/or rotatable relative to opening 128 via a mechanism which has at least one hinge. Alternatively, display panel 112 may be planar.

In the second embodiment of the method according to the present disclosure, at least two modes are provided for display panel 112, which may include a projection mode shown in FIG. 2 and a covering mode. In the embodiment shown in FIG. 2, in the covering mode, display panel 112 may be pivoted downwards, with opening 128 being covered and/or closed by display panel 112. In such an embodiment, display panel 112 may be arranged in opening 128 as part of housing 126.

In contrast, in the projection mode, display panel 112 may be pivoted upward out of opening 128, with opening 128 being uncovered and/or opened. In the embodiment shown in FIGS. 2, a reflective or mirrored surface of display panel 112 may face steering wheel 102. In the method, an original image 114 may be generated by display field 108 and emitted and/or projected upward onto the mirrored surface of display panel 112. From there, image 114 may be reflected in the direction of steering wheel 102 and into the interior. In such an embodiment, a viewer, such as a driver of the vehicle, may visually perceive a resulting virtual image 114 in the interior behind the steering wheel 102, which may appear to the viewer behind display panel 112.

German patent application no. 10 2024 108 820.6, filed Mar. 27, 2024, to which this application claims priority, is hereby incorporated by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A display system for a vehicle having a steering column with a housing and a steering wheel rotatably arranged thereon, the display system comprising:
at least one optical module;
one opening in an upper side of the housing; and
one display panel,
wherein the at least one optical module is arranged within the housing of the steering column,
wherein the display panel is arranged on the upper side of the housing and is configured to be movable relative to the opening, to cover the opening in the upper side of the steering column in a covering mode, and to uncover the opening in the upper side of the steering column in a projection mode,
wherein the at least one optical module is configured to emit an image through the uncovered opening in the housing onto the display panel when the display panel is in the projection mode, and
wherein the display panel is configured to reflect the image emitted thereon into an interior of the vehicle.

2. The display system according to claim 1, wherein an optical module of the at least one optical module is a display field within the housing of the steering column, the display field configured to generate the image.

3. The display system according to claim 2, wherein the display field is configured to emit the image through the uncovered opening in the housing onto the display panel when the display panel is in the projection mode.

4. The display system according to claim 2, wherein a further optical module of the at least one optical module is a mirror within the housing of the steering column,
wherein the display field is configured emit the image onto the mirror, and
wherein the mirror is configured to reflect the image through the uncovered opening in the housing onto the display panel when the display panel is in the projection mode.

5. The display system according to claim 4, wherein the mirror is arranged in the steering column in front of the display field with respect to a forward travel direction of the vehicle, and
wherein the display panel is arranged above the mirror in the projection mode.

6. The display system according to claim 1, wherein the display panel is at least partially curved.

7. The display system according to claim 6, wherein a curve of the display panel is concave.

8. The display system according to claim 1, wherein the display panel is at least partially planar.

9. The display system according to claim 1, wherein the display panel is at least partially transparent.

10. The display system according to claim 1, wherein the display panel is at least partially opaque.

11. The display system according to claim 1, wherein the display panel is at least partially mirrored.

12. The display system according to claim 1, further comprising a mechanism configured to pivot the display panel relative to the opening between the covering mode and the projection mode.

13. The display system according to claim 1, wherein the steering column of the vehicle includes a steering shaft arranged therein, the steering shaft configured to connect the steering wheel to a steering system for wheels of the vehicle.

14. A method for operating a display system for a vehicle having a steering column with a housing and a steering wheel rotatably arranged thereon, the display system comprising:
at least one optical module;
one opening in an upper side of the housing; and
one display panel,
wherein the at least one optical module is arranged within the housing of the steering column,
wherein the display panel is arranged on the upper side of the housing so as to be movable relative to the opening, and
wherein the opening in the upper side of the steering column is covered by the display panel in a covering mode and is uncovered in a projection mode,
the method for operating the display system comprising:
emitting an image by the at least one optical module through the uncovered opening in the housing onto the display panel when the display panel is in the projection mode; and
reflecting the image from the display panel into an interior of the vehicle.

15. The method according to claim 14, further comprising moving the display panel between the covering mode and the projection mode.
